(19) United States
(12) Patent Application Publication
(10) Pub. No.: US 2026/0301621 A1
(43) Pub. Date: Oct. 1, 2026

(54) VOLTAGE DETECTION CIRCUIT, DISPLAY DRIVER, AND DISPLAY DEVICE

(71) Applicant: ROHM CO., LTD., Kyoto (JP)

(72) Inventors: Koya SUGIHARA, Kyoto (JP); Koji TAKEDA, Oita (JP)

(73) Assignee: ROHM CO., LTD., Kyoto (JP)

(21) Appl. No.: 19/568,290

(22) Filed: Mar. 16, 2026

(30) Foreign Application Priority Data
Mar. 28, 2025 (JP) 2025-055445

(51) Int. Cl. G09G 3/00

(52) U.S. Cl. CPC G09G 3/006; G09G 2310/0267; G09G 2310/0275; G09G 2330/12

(57) ABSTRACT

A voltage detection circuit includes a bias unit having first and second transistors with respective drains connected to each other via a first node, and receiving a reference voltage at respective gates to generate a bias voltage at the first node. Third and fourth transistors of the bias unit output a current corresponding to the bias voltage to the first transistor while drawing out the same current from the second transistor. First to n-th detection units of the voltage detection circuit include fifth and sixth transistors having respective drains connected to each other and receiving one of first to n-th voltages as detection target voltages, and outputting a voltage produced at each drain as a voltage detection signal. Seventh and eighth transistors of the voltage detection circuit output a current corresponding to the bias voltage to the fifth transistor while drawing out the same current from the sixth transistor.

### CROSS REFERENCE TO RELATED APPLICATION

This application is based upon and claims the benefit of priority of the prior Japanese Patent Application No. 2025-055445, filed on Mar. 28, 2025, the entire contents of which are incorporated herein by reference.

### SUMMARY

This disclosure relates to a voltage detection circuit, a display driver that includes the voltage detection circuit, and a display device.

Currently, active-matrix display devices constituted of a display panel using liquid crystal or organic EL technology, and source and gate drivers that drive the display panel are commonly known.

In the display panel, a plurality of data lines extending vertically across the two-dimensional screen and a plurality of gate lines extending horizontally across the two-dimensional screen are arranged to intersect each other on an insulating transparent substrate such as glass or plastic. At each intersection of the plurality of data lines and the plurality of gate lines, a pixel unit connected to the data line and the gate line is formed. The gate driver supplies gate selection signals sequentially to the respective gate lines of the display panel. The source driver supplies a plurality of output signals, each having a voltage value corresponding to the brightness level of each pixel based on the video signal, to the respective data lines, thereby displaying an image based on the video signal on the display panel.

In recent years, display panels have become higher in resolution, and as the reduction in pixel pitch causes the wiring width and spacing to be smaller, the risk of malfunctions has been increasingly higher. Therefore, particularly in display panels for automotive applications, there is a growing demand for the inclusion of a fault detection function that can quickly detect abnormalities in the display panel in order to avoid image sticking, or image freezing.

In response to this demand, a liquid crystal display device equipped with such a fault detection function has been proposed (see, for example, FIGS. 1 and 4 of Japanese Patent Application Laid-open Publication No. 2000-275610 (Patent Document 1)). In this liquid crystal display device, the output signal that the source driver outputs to the data line and a predetermined reference voltage are compared by comparators (COMP1, COMP2) acting as voltage detection circuits, and the comparison result is outputted as a detection signal indicating whether or not a voltage abnormality has occurred.

Furthermore, a self-bias negative feedback differential amplifier type comparator circuit has been proposed as this type of voltage detection circuit (see FIG. 1 of Japanese Patent Application Laid-open Publication No. 2006-332793 (Patent Document 2)).

### BRIEF DESCRIPTION OF THE DRAWINGS

FIG. 1 is a circuit diagram illustrating a configuration of a voltage detection circuit 100 of Embodiment 1.

FIG. 2 is a waveform diagram showing an example of the waveforms of voltage detection signals OT1 and OTn outputted by detection units 30_1 and 30_n, based on voltages V1 and Vn that follow the fluctuations of a main power supply voltage VDD.

FIG. 3 is a diagram illustrating the relationship between the logical values of the voltage detection signals OT1 and OTn and the state of the main power supply voltage VDD.

FIG. 4 is a circuit diagram illustrating a configuration of a voltage detection circuit 100A of Embodiment 2.

FIG. 5 is a waveform diagram showing an example of the waveforms of voltage detection signals OT1 and OT2 outputted by detection units 30_1 and 30_2, based on voltages V1 and V2 that follow the fluctuations of a power supply voltage VSP.

FIG. 6 is a diagram illustrating the relationship between the logical values of the voltage detection signals OT1 and OT2 and the state of the power supply voltage VSP.

FIG. 7 is a block diagram illustrating a configuration of a display device 300 that includes a display driver IC 150 of Embodiment 3.

### DETAILED DESCRIPTION

### Embodiment 1

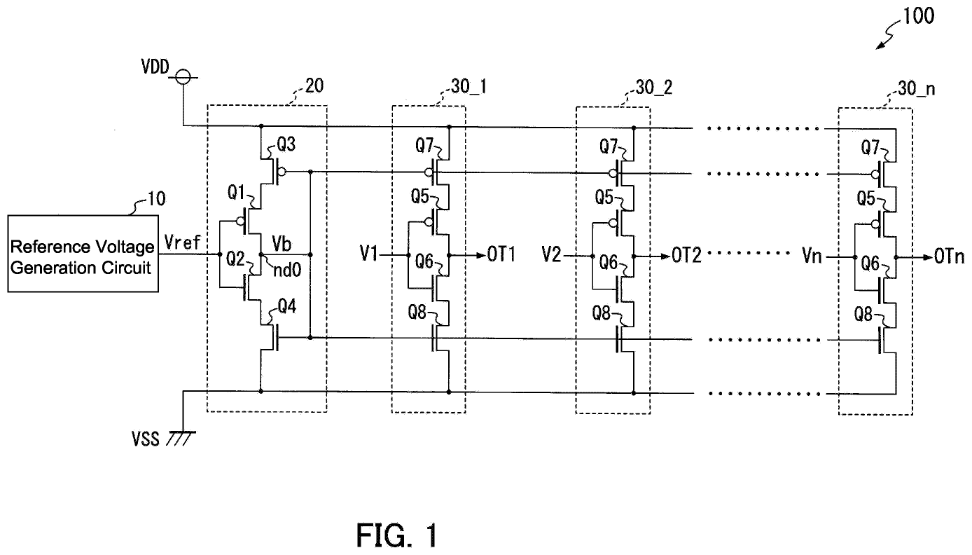

FIG. 1 is a circuit diagram illustrating the configuration of a voltage detection circuit 100 of Embodiment 1 of the present disclosure.

The voltage detection circuit 100 receives n-series voltages V1 to Vn (n is an integer of 2 or greater) as detection target voltages, compares the sizes of the voltages V1 to Vn with the size of a reference voltage Vref individually, and outputs voltage detection signals OT1 to OTn each indicating the comparison result by a binary value (logical value L or H).

As illustrated in FIG. 1, the voltage detection circuit 100 includes a reference voltage generation circuit 10, a self-bias unit 20, and detection units 30_1 to 30_n.

The reference voltage generation circuit 10 is a band-gap reference circuit and the like, for example, generating an absolute reference voltage that does not depend on the main power supply voltage VDD, ambient temperatures, or manufacturing process, and supplying this voltage to the self-bias unit 20 as the reference voltage Vref.

The self-bias unit 20 includes P-channel type transistors Q1 and Q3 and N-channel type transistors Q2 and Q4.

The transistor Q1 has the gate connected to the gate of the transistor Q2, and receives the reference voltage Vref at the gate thereof. The transistor Q1 has the drain connected to the drain of the transistor Q2 via a node nd0.

The transistor Q2 has the source connected to the drain of the transistor Q4.

The transistor Q3 receives the main power supply voltage VDD at the source thereof, and has the drain connected to the source of the transistor Q1. The transistor Q3 has the gate connected to the drains of the transistors Q1 and Q2 via the node nd0.

The transistor Q4 receives a power supply voltage VSS (e.g. zero volts) at the source thereof, and has the gate connected to the node nd0.

The reference voltage Vref, and main power supply voltage VDD and the power supply voltage VSS have the following relationship:
VDD>Vref>VSS.

With this configuration, in the self-bias unit 20, the transistors Q1 and Q2 are turned on by the reference voltage Vref, and a voltage corresponding to the reference voltage Vref is generated at the node nd0. For example, if the reference voltage Vref is set to half of the main power supply voltage VDD (VDD/2), then approximately VDD/2 voltage is generated at the node nd0. The self bias unit 20 supplies this voltage produced at the node nd0 to the respective gates of the transistors Q3 and Q4 as a bias voltage Vb. This turns on both transistors Q3 and Q4, and causes a bias current based on the main power supply voltage VDD to flow through the channel constituted of the transistors Q3, Q1, Q2 and Q4, and a voltage produced at the node nd0 because of this is generated as the bias voltage Vb.

The self bias unit 20 supplies this bias voltage Vb not only to the respective gates of the transistors Q3 and Q4, but also to the respective detection units 30_1 to 30_n.

Each of the detection unit 30_1 to 30_n has the same internal configuration, or in other words, includes p-channel type transistors Q7 and Q5 and n-channel type transistors Q6 and Q8.

In the transistor Q5, the gate is connected to the gate of the transistor Q6, and the drain is connected to the drain of the transistor Q6.

The transistor Q6 has the source connected to the drain of the transistor Q8.

The transistor Q7 receives the main power supply voltage VDD at the source thereof, and has the drain connected to the source of the transistor Q5. The transistor Q7 has the gate connected to the node nd0 and receives the bias voltage Vb via the node nd0.

The transistor Q8 receives the power supply voltage VSS (e.g., zero volts) at the source thereof, and has the drain connected to the source of the transistor Q6. The transistor Q8 has the gate connected to the node nd0 and receives the bias voltage Vb via the node nd0.

The detection unit 30_1 to 30_n receive voltage V1 to Vn, respectively, as the detection targets at each connecting point of the gate of its own transistor Q5 and the gate of its own transistor Q6. The detection units 30_1 to 30_n output voltage detection signals OT1 to OTn from each connecting point of the drain of its own transistor Q5 and the drain of its own transistor Q6.

Next, the operation of the voltage detection circuit 100 will be explained in detail.

First, the self-bias unit 20 generates a bias voltage Vb of the size corresponding to the reference voltage Vref, and supplies this to the gates of the transistors Q7 and Q8 of the detection units 30_1 to 30_n, respectively. In response, the transistor Q7 of each of the detection units 30_1 to 30_n sends out a bias current of the size corresponding to the bias voltage Vb to the source of the transistor Q5. Furthermore, the transistor Q8 of each of the detection units 30_1 to 30_n draws out a bias current of the size corresponding to this bias voltage Vb from the source of the transistor Q6. Since the reference voltage Vref is set to (VDD/2) in this embodiment, the bias current sent from the transistor Q7 to the transistor Q5 is equal to the bias current drawn out from the transistor Q6 by the transistor Q8.

In each of the detection units 30_1 to 30_n, or in other words, in a detection unit 30_r (r is an integer of 1 to n), the transistors Q5 and Q6 are turned on by the voltage Vr applied thereto. If the voltage Vr is higher than the reference voltage Vref, the current sent by the transistor Q7 to the connecting point of the drains of the transistors Q5 and Q6 is smaller than the current drawn out by the transistor Q8 from this connecting point. As a result, the voltage at the connecting point decreases to the power supply voltage VSS (e.g., zero volts), causing the detection unit 30_r to output a voltage detection signal OTr with a logical value L corresponding to the power supply voltage VSS.

If the voltage Vr is equal to or lower than the reference voltage Vref, the current sent by the transistor Q7 to the connecting point of the drains of the transistors Q5 and Q6 is greater than the current drawn out by the transistor Q8 from this connecting point. As a result, the voltage at the connecting point increases to the main power supply voltage VDD, causing the detection unit 30_r to output a voltage detection signal OTr with a logical value H.

In this way, in the voltage detection circuit 100, the first to n-th detection units 30_1 to 30_n receive first to n-th voltages V1 to Vn as detection targets, and compare the sizes of the first to n-th voltages V1 to Vn with the size of the reference voltage Vref. Then, the voltage detection circuit 100 outputs first to n-th voltage detection signals OT1 to OTn for the respective first to n-th voltages V1 to Vn that indicate whether those voltages are higher than the reference voltage Vref or not.

As described above, the voltage detection circuit 100 includes the self-bias unit 20 that receives the reference voltage Vref and generates a bias voltage Vb based on this reference voltage Vref, and the first to n-th detection units 30_1 to 30_n that respectively receive the first to n-th voltages V1 to Vn and output the first to n-th voltage detection signals OT1 to OTn, respectively.

The self-bias unit 20 is constituted of the following first to fourth transistors Q1 to Q4. That is, the first transistor Q1 and the second transistor Q2 have conductivity types differing from each other (P-channel type and N-channel type), and are configured such that the respective drains are connected to each other via the first node nd0 and the respective gates receive the reference voltage Vref. This causes the first transistor Q1 and the second transistor Q2 to generate a bias voltage Vb, which is the voltage produced at the first node nd0. The third transistor Q3 receives the first power supply voltage VDD at the source thereof, and the bias voltage Vb at the gate thereof, and sends out a current corresponding to the bias voltage Vb to the source of the first transistor Q1. The fourth transistor Q4 receives the second power supply voltage VSS that has a lower voltage value than the first power supply voltage VDD at the source thereof, and receives the bias voltage Vb at the gate thereof, thereby drawing out a current that corresponds to the bias voltage Vb from the source of the second transistor Q2.

On the other hand, each of the first to n-th detection units 30_1 to 30_n is constituted of the fifth to eighth transistors. That is, the fifth transistor Q5 and the sixth transistor Q6 have conductivity types differing from each other, and are configured such that the respective drains are connected to each other and the respective gates receive one of the first to n-th voltages V1 to Vn, thereby outputting the voltage generated at each drain as one of the first to n-th voltage detection signals OT1 to OTn. The seventh transistor Q7 receives the first power supply voltage VDD at the source thereof, and the bias voltage Vb at the gate thereof, and sends out a current that corresponds to the bias voltage Vb to the source of the fifth transistor Q5. The eighth transistor Q8 receives the second power supply voltage VSS that has a lower voltage value than the first power supply voltage VDD at the source thereof, and receives the bias voltage Vb at the gate thereof, thereby drawing out a current that corresponds to the bias voltage Vb from the source of the sixth transistor Q6.

Therefore, in the configuration of the voltage detection circuit 100 shown in FIG. 1, the total number of transistors required to compare each of the n-series voltages V1 to Vn as the detection target voltages with the reference voltage Vref is 4+4n; the sum of 4 transistors in the self-bias unit 20 and 4n transistors in the detection units 30_1 to 30_n.

Thus, according to the voltage detection circuit 100, it is possible to reduce the circuit area as compared to the configuration that uses n comparators each constituted of six transistors as shown in FIG. 1 of Patent Document 2, which requires 6n transistors in total.

Furthermore, in the voltage detection circuit 100, as illustrated in FIG. 1, because each of the detection units 30_1 to 30_n has the seventh and eighth transistors Q7 to Q8 for the bias current to flow, it is possible to increase the maximum voltage value of the voltage detection signals OT1 to OTn to the main power supply voltage VDD.

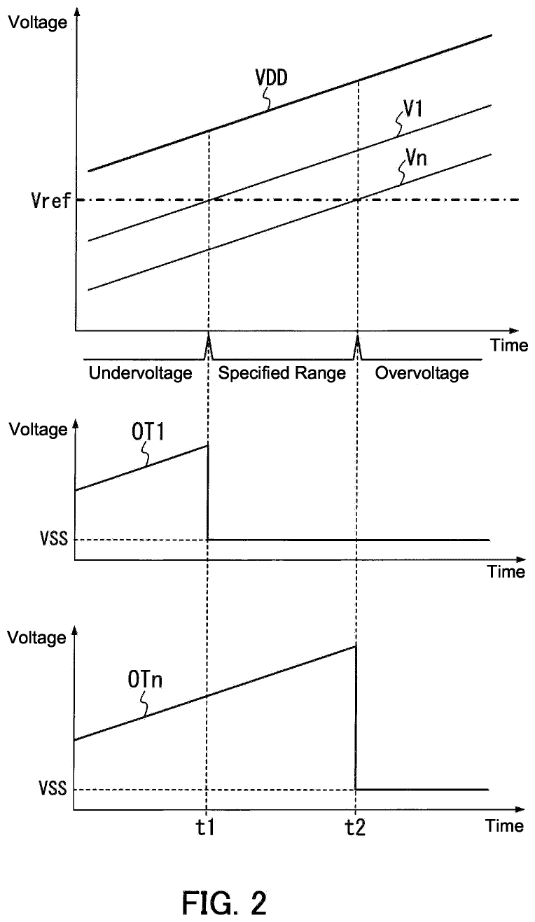

FIG. 2 is a waveform diagram of the detection units 30_1 and 30_n selected from the detection units 30_1 to 30_n, showing an example of the waveforms of voltage detection signals OT1 and OTn outputted by the detection units 30_1 and 30_n based on the supplied voltages V1 and Vn.

FIG. 2 shows the waveforms of the voltage detection signals OT1 and OTn obtained when the relationship between the main power supply voltage VDD, voltage V1, and voltage Vn is VDD>V1>V2, and when these voltages V1 and V2 fluctuate in accordance with the fluctuations of the main power supply voltage VDD.

As illustrated in FIG. 2, when the voltage value of the voltage V1 is equal to or less than the reference voltage Vref, the detection unit 30_1 outputs a voltage detection signal OT1 with the logical value H having the same voltage value as the main power supply voltage VDD. At time t1 in FIG. 2, when the voltage value of the voltage V1 exceeds the reference voltage Vref, the detection unit 30_1 outputs a voltage detection signal OT1 with the logical value L having the same voltage value as the power supply voltage VSS (e.g., zero volts).

Also, as illustrated in FIG. 2, when the voltage value of the voltage Vn is equal to or less than the reference voltage Vref, the detection unit 30_n outputs a voltage detection signal OTn with the logical value H having the same voltage value as the main power supply voltage VDD. At time t2 in FIG. 2, when the voltage value of the voltage Vn exceeds the reference voltage Vref, the detection unit 30_n outputs a voltage detection signal OTn with the logical value L having the same voltage value as the power supply voltage VSS (e.g., zero volts).

The voltage detection circuit 100 can detect whether the voltage value of the main power supply voltage VDD is lower than a prescribed level (undervoltage state) or higher than the prescribed level (overvoltage state), or in other words, can perform a voltage abnormality detection.

For example, as illustrated in FIG. 2, two voltages whose values change in accordance with the fluctuations of the main power supply voltage VDD are supplied to the detection units 30_1 and 30_n as voltages V1 and Vn, respectively (VDD>V1>Vn). Here, the voltage V1 is a threshold to determine that the main power supply voltage VDD is in the undervoltage state, and the voltage Vn is a threshold to determine that the main power supply voltage VDD is in the overvoltage state.

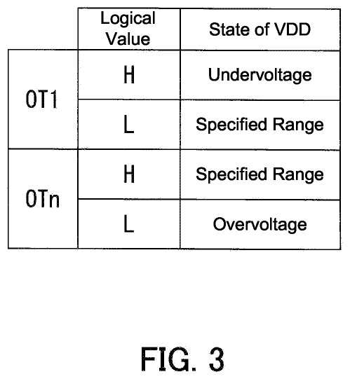

When the voltage value of the voltage V1 is equal to or less than the reference voltage Vref, the detection unit 30_1 outputs the voltage detection signal OT1 with the logical value H having the same voltage value as the main power supply voltage VDD. In this case, as illustrated in FIG. 3, it can be determined that the main power supply voltage VDD is in the undervoltage state based on the voltage detection signal OT1 with the logical value H.

On the other hand, when the voltage value of the voltage Vn is greater than the reference voltage Vref, the detection unit 30_n outputs a voltage detection signal OTn with the logical value L having the same voltage value as the power supply voltage VSS (e.g., zero volts). In this case, as illustrated in FIG. 3, it can be determined that the main power supply voltage VDD is in the overvoltage state based on the voltage detection signal OTn with the logical value L.

That is, as illustrated in FIG. 3, when the voltage detection signal OT1 indicates the logical value L, and the voltage detection signal OTn indicates the logical value H, it can be determined that the voltage value of the main power supply voltage VDD is within the specified range.

### Embodiment 2

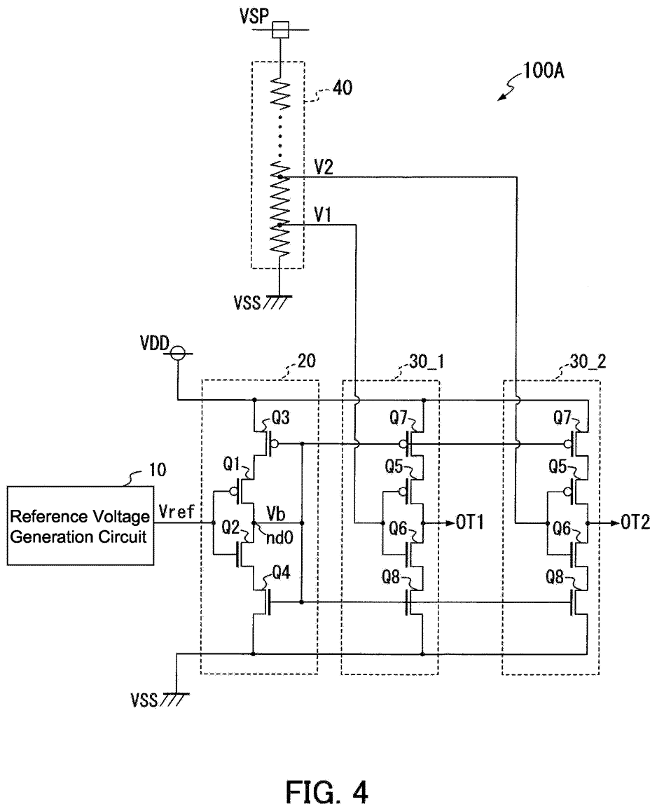

FIG. 4 is a circuit diagram illustrating a configuration of a voltage detection circuit 100A of Embodiment 2 of the present disclosure.

The voltage detection circuit 100A identifies a power supply voltage VSP as a detection target voltage that is independent of the main power supply voltage VDD, and detects whether that voltage value is lower than a prescribed level (undervoltage state) or higher than the prescribed level (overvoltage state), or in other words, can perform a voltage abnormality detection.

As illustrated in FIG. 4, the voltage detection circuit 100A uses only the detection units 30_1 and 30_2 out of the detection units 30_1 to 30_n illustrated in FIG. 1, and additionally has a detection voltage generation circuit 40. Other configurations (reference voltage generation circuit 10 and self-bias unit 20) are the same as those of FIG. 1.

The detection voltage generation circuit 40 is made of a resistor string, for example, and generates a voltage V1 and a voltage V2 by dividing the power supply voltage VSP. The voltage V1 is a threshold value corresponding to the lower limit of the specified range of the power supply voltage VSP, and the voltage V2 is a threshold value corresponding to the upper limit of the specified range. The detection voltage generation circuit 40 supplies the generated voltage V1 to the detection unit 30_1, and the generated voltage V2 to the detection unit 30_2.

Next, the operation of the voltage detection circuit 100A will be explained.

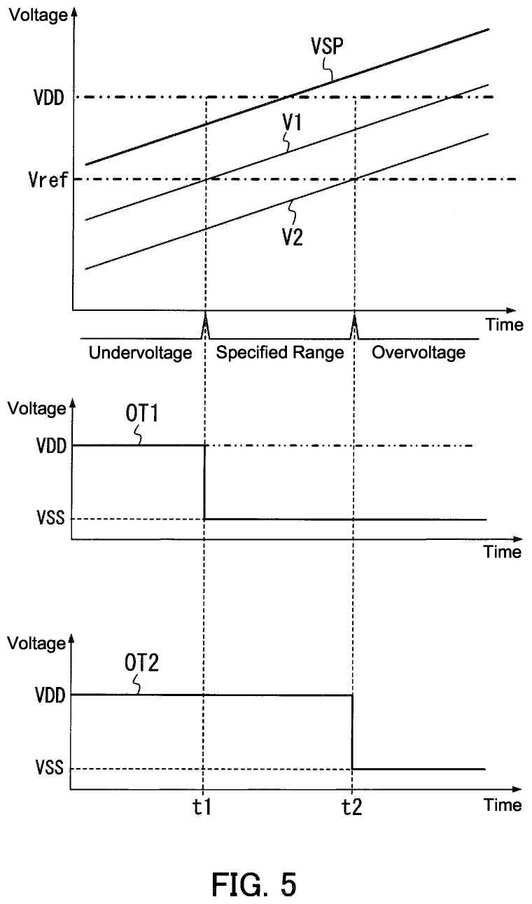

FIG. 5 is a waveform diagram showing an example of the waveforms of the voltages V1 and V2 whose voltage values fluctuate in accordance with the fluctuations of the power supply voltage VSP, and the voltage detection signals OT1 and OT2 outputted by the detection units 30_1 and 30_2 based on the voltages V1 and V2.

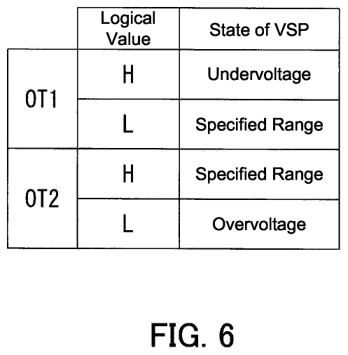

As illustrated in FIG. 5, when the voltage value of the voltage V1 is equal to or less than the reference voltage Vref, the detection unit 30_1 outputs a voltage detection signal OT1 with the logical value H having the same voltage value as the main power supply voltage VDD. In this case, as illustrated in FIG. 6, it can be determined that the power supply voltage VSP is in the undervoltage state based on the voltage detection signal OT1 with the logical value H.

On the other hand, when the voltage value of the voltage V2 is greater than the reference voltage Vref, the detection unit 30_2 outputs the voltage detection signal OT2 with the logical value L having the same voltage value as the power supply voltage VSS (e.g. zero volts). In this case, as illustrated in FIG. 6, it can be determined that the power supply voltage VSP is in the overvoltage state based on the voltage detection signal OT2 with the logical value L.

That is, as illustrated in FIG. 6, when the voltage detection signal OT1 indicates the logical value L, and the voltage detection signal OT2 indicates the logical value H, it can be determined that the voltage value of the power supply voltage VSP is within the specified range.

### Embodiment 3

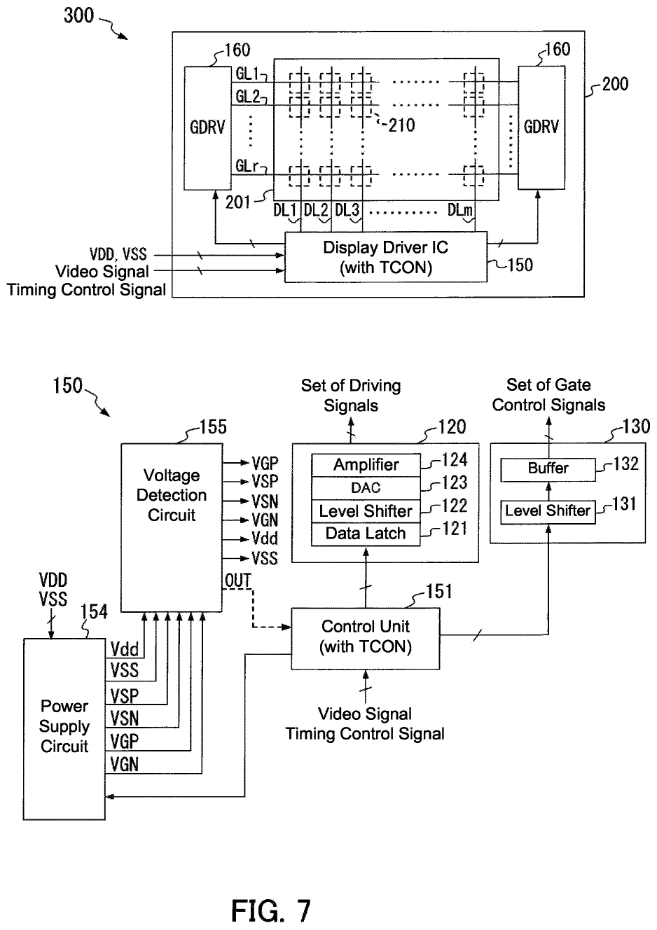

FIG. 7 is a block diagram illustrating the configuration of a display device 300 that includes a display driver IC 150 of Embodiment 3 of the present disclosure.

The display device 300 has a GIP (Gate in Panel) structure formed integrally with the display unit and constituted of a display panel 200, gate drivers 160, and a display driver IC 150.

The display panel 200 includes a display unit 201 on an insulating substrate such as a glass substrate or plastic substrate, gate lines GL1 to GLr (r is an integer of 2 or greater) arranged horizontally, data lines DL1 to DLm (m is an integer of 2 or greater) arranged vertically, and pixel cells 210 arranged at respective intersections of the gate lines and data lines. The gate drivers 160 that output gate selection signals to the respective gate lines are placed at both ends of the panel and integrated with the pixel cells 210 as a thin-film semiconductor circuit. The gate drivers 160 receive gate control signals supplied from the display driver IC 150, generate gate selection signals to be supplied to the respective gate lines GL1 to GLr, and sequentially output these gate selection signals to the respective gate lines.

The display driver IC 150 is constituted of a semiconductor IC including a control unit 151 with a built-in timing controller, a data driver 120, a gate control circuit 130, a power supply circuit 154, and a voltage detection circuit 155. The display driver IC 150 is mounted on an edge of the display panel 200 directly or having a film therebetween. Depending on the resolution of the display panel, more than one display driver ICs 150 may be mounted. FIG. 7 shows an example of the configuration in which one display driver IC 150 is mounted.

Based on externally inputted video data signals and timing control signals, the control unit 151 generates timing signals indicating the timing for applying gate selection signals to the respective gate lines GL1 to GLr, and supplies these signals to the gate control circuit 130.

Furthermore, the control unit 151 generates various control signals, including clock signals and load signals, as well as video data signals containing a series of pixel data pieces representing the brightness level of each pixel as a digital value, based on externally inputted video data signals and timing control signals, and supplies these to the data driver 120.

The gate control circuit 130 receives the timing signal supplied from the control unit 151, level-shifts it to a high level using a level shifter 131, amplifies the level-shifted signal with a buffer 132, and outputs it as a gate control signal via the display driver IC 150 to the gate drivers 160 formed at both ends of the display panel 200.

The data driver 120 includes a data latch 121, a level shifter 122, a digital-to-analog (DA) converter (DAC) 123, and an amplifier 124. The data latch 121 receives each pixel data piece included in the video data signal for one horizontal scan line at a time (m pieces), and supplies the m pieces of pixel data that have been received to the level shifter 122. The level shifter 122 supplies the DA converter 123 with the m pieces of pixel data each having the signal level shifted to a higher level. The DA converter 123 converts each of the m pieces of pixel data individually into a grayscale voltage signal having an analog voltage value corresponding to the brightness level indicated by each pixel data piece. The DA converter 123 supplies the m grayscale voltage signals obtained through the conversion to the amplifier 124. The amplifier 124 amplifies the m grayscale voltage signals individually and supplies them as driving signals to the data lines DL1 to DLm of the display panel 200, respectively.

The power supply circuit 154 receives the main power supply voltage VDD and the power supply voltage VSS (e.g., zero volts), and generates a power supply voltage Vdd for the logic circuit based on the main power supply voltage VDD. The power supply circuit 154 generates a positive source power supply voltage VSP having positive polarity and a negative source power supply voltage VSN having negative polarity as power supply for the data driver 120. The power supply circuit 154 also generates, as power supply for the gate control circuit 130, a positive gate power supply voltage VGP having positive polarity and a negative gate power supply voltage VGN having negative polarity that turn on and off the thin-film transistors included in the pixel cells 210 of the display panel 200.

The power supply circuit 154 supplies the power supply voltage Vdd and power supply voltage VSS to the control unit 151.

Also, the power supply circuit 154 supplies the positive gate power supply voltage VGP and the negative gate power supply voltage VGN to the gate control circuit 130, and supplies the power supply voltage VSS, the positive source power supply voltage VSP, and the negative source power supply voltage VSN to the data driver 120.

Furthermore, the power supply circuit 154 supplies the power supply voltage Vdd, the power supply voltage VSS, the positive source power supply voltage VSP, the negative source power supply voltage VSN, the positive gate power supply voltage VGP, and the negative gate power supply voltage VGN to the voltage detection circuit 155.

The voltage detection circuit 155 includes the reference voltage generation circuit 10, the self-bias unit 20, and the detection units 30_1 to 30_5 of the voltage detection circuit 100 illustrated in FIG. 1.

In the voltage detection circuit 155, the power supply voltage Vdd, positive gate power supply voltage VGP, positive source power supply voltage VSP, negative source power supply voltage VSN, and negative gate power supply voltage VGN are received by the detection units 30_1 to 30_5 as the voltages V1 to V5, respectively.

In response, the detection units 30_1 to 30_5 respectively output voltage detection signals OT1 to OT5 for the power supply voltage Vdd, the positive gate power supply voltage VGP, the positive source power supply voltage VSP, the negative source power supply voltage VSN, and the negative gate power supply voltage VGN that indicate whether each voltage value is greater than the reference voltage Vref or not.

Here, the voltage detection circuit 155 divides the positive gate power supply voltage VGP, the positive source power supply voltage VSP, the negative source power supply voltage VSN, and the negative gate power supply voltage VGN into two power supply voltage groups: one group where a voltage abnormality is determined if the voltage value is higher than the reference voltage Vref, and another group where a voltage abnormality is determined if the voltage value is less than or equal to the reference voltage Vref.

If at least one of the positive gate power supply voltage VGP, the positive source power supply voltage VSP, the negative source power supply voltage VSN, and the negative gate power supply voltage VGN is determined to be abnormal, the voltage detection circuit 155 supplies a voltage abnormality detection signal OUT to the control unit 151 indicating that a power supply voltage abnormality has occurred.

Upon receiving the voltage abnormality detection signal OUT indicating that a power supply voltage abnormality has occurred, the control unit 151 instructs the gate control circuit 130 to output a gate control signal that deactivates the operation of the gate drivers 160, and also sets the operation of the data driver 120 to an inactive state. This makes it possible to prevent damage and abnormal displays caused by power supply voltage abnormalities. The control unit 151 may also be configured to stop the operation of the power supply circuit 154 upon receiving the voltage abnormality detection signal OUT described above.

The voltage detection circuit 155 may have an alternative configuration where the voltage detection circuit 100A illustrated in FIG. 4 is provided for each of the positive gate power supply voltage VGP, the positive source power supply voltage VSP, the negative source power supply voltage VSN, and the negative gate power supply voltage VGN. In this case, for example, in the voltage detection circuit 100A provided for the positive gate power supply voltage VGP, the detection voltage generation circuit 40 receives the positive gate power supply voltage VGP instead of the power supply voltage VSP shown in FIG. 4. The voltage detection circuit 155 supplies a voltage abnormality detection signal OUT to the control unit 151, indicating that a power supply voltage abnormality exceeding the specified range has occurred, when the voltage detection signal OT1 generated by at least one of the voltage detection circuits 100A provided for the power supply voltages VGP, VSP, VSN, and VGN, respectively, indicates the logical value H, or when the voltage detection signal OT2 indicates the logical value L.

The voltage detection circuit 155 may be configured to perform the voltage detection described above not only for the voltages mentioned above (VDD, VGP, VSP, VSN, VGN), but also for various voltages generated by internal regulators and other external power supplies.

As described above, the voltage detection circuit according to the embodiments described above allows for the comparison of each of the first to n-th voltages with a reference voltage using a total of (4+4n) transistors, that is, a bias unit that includes four transistors and first to n-th detection units that each include four transistors. The first to n-th detection units are operated by a bias current generated based on the bias voltage produced by the bias unit.

Therefore, with this voltage detection circuit, the circuit area can be reduced as compared to the configuration that uses n comparators 10 each including six transistors to compare the first to n-th voltages with the reference voltage as disclosed in Patent Document 2.

What is claimed is:

1. A voltage detection circuit that compares a size of each of first to n-th voltages, n being an integer of 2 or greater, with a size of a reference voltage, and outputs first to n-th voltage detection signals that respectively indicate whether the first to n-th voltages are higher than the reference voltage or not, comprising:
a bias unit that receives the reference voltage and that generates a bias voltage based on the reference voltage; and
first to n-th detection units that respectively receive the first to n-th voltages and respectively output the first to n-th voltage detection signals,
wherein the bias unit includes:
first and second transistors of different conductivity types from each other configured to have respective drains connected to each other via a first node and receive the reference voltage at respective gates to generate a voltage produced at the first node as the bias voltage;
a third transistor that receives a first power supply voltage at a source of the third transistor and the bias voltage at a gate of the third transistor, and that sends out a current that corresponds to the bias voltage to a source of the first transistor; and
a fourth transistor that receives a second power supply voltage that is lower than the first power supply voltage at a source of the fourth transistor and the bias voltage at a gate of the fourth transistor, and that draws out a current that corresponds to the bias voltage from a source of the second transistor, and
wherein each of the first to n-th detection unit includes:
fifth and sixth transistors of different conductivity types from each other configured to have respective drains connected to each other and receive one of the first to n-th voltages at each gate of the fifth and sixth transistors to output a voltage produced at each drain of the fifth and sixth transistors as one voltage detection signal of the first to n-th voltage detection signals;
a seventh transistor that receives the first power supply voltage at a source of the seventh transistor and the bias voltage at a gate of the seventh transistor, and that sends out a current that corresponds to the bias voltage to a source of the fifth transistor; and
an eighth transistor that receives the second power supply voltage at a source of the eighth transistor and the bias voltage at a gate of the eighth transistor, and that draws out a current that corresponds to the bias voltage from a source of the sixth transistor.

2. The voltage detection circuit according to claim 1, wherein a detection unit of the first to n-th detection units outputs, as said one voltage detection signal, a binary signal that has a first power supply voltage when one voltage of the first to n-th voltages applied to the detection unit of the first to n-th detection units is less than or equal to the reference voltage, or has a second power supply voltage when said one voltage is higher than the reference voltage.

3. The voltage detection circuit according to claim 1, wherein said n is 2,
wherein the voltage detection circuit further includes a detection voltage generation circuit configured to receive a third power supply voltage as a detection target voltage, generate two voltages having voltage values differing from each other by dividing the third power supply voltage, and supply a voltage with a higher voltage value between the two voltages to the first detection unit as a first voltage and a voltage with a lower voltage value between the two voltages to the second detection unit as a second voltage, the first voltage indicating a threshold corresponding to a lower limit of a specified range of the third power supply voltage, and the second voltage indicating a threshold corresponding to an upper limit of the specified range,
wherein each of the first and second voltage detection signals is a binary signal that has the first power supply voltage when the first voltage or the second voltage is less than or equal to the reference voltage, or has the second power supply voltage when the first voltage or the second voltage is higher than the reference voltage, and
wherein, if the first voltage detection signal has the first power supply voltage, the voltage detection circuit indicates that the third power supply voltage is in a undervoltage state that is lower than the lower limit of the specified range, and if the second voltage detection signal has the second power supply voltage, the voltage detection circuit indicates that the third power supply voltage is in an overvoltage state that is higher than the upper limit of the specified range.

4. A display driver including the voltage detection circuit according to claim 1 and a control unit, and configured to drive a display panel in which a plurality of data lines and a plurality of gate lines are arranged to intersect with each other, the display driver comprising:
a data driver that generates a plurality of driving signals based on a video signal and that supplies the driving signals to the plurality of data lines;
a gate control circuit that outputs a gate control signal to a gate driver that is integrally formed with the display panel and that supplies gate selection signals to the plurality of gate lines based on the gate control signal; and
a power supply circuit that receives the first power supply voltage and that generates a first positive power supply voltage and a first negative power supply voltage for operating the gate control circuit, and a second positive power supply voltage and a second negative power supply voltage for operating the data driver based on the first power supply voltage,
wherein, in the voltage detection circuit, the first to fifth detection units receive the first power supply voltage, the first positive power supply voltage, the first negative power supply voltage, the second positive power supply voltage, and the second negative power supply voltage as the first to fifth voltages, respectively, and
wherein the control unit deactivates the data driver and the gate driver when at least one of the first to fifth voltage detection signals outputted from the first to fifth detection units exceeds a specified range.

5. A display device having a display panel in which a plurality of data lines and a plurality of gate lines are arranged to intersect with each other, a display driver including the voltage detection circuit according to claim 1, and a control unit, and configured to drive the display panel, the display device comprising:
a data driver that generates a plurality of driving signals based on a video signal and that supplies the driving signals to the plurality of data lines;
a gate control circuit that outputs a gate control signal to a gate driver integrally formed with the display panel and supplying gate selection signals to the plurality of gate lines based on the gate control signal; and
a power supply circuit that receives the first power supply voltage and that generates a first positive power supply voltage and a first negative power supply voltage for operating the gate control circuit, and a second positive power supply voltage and a second negative power supply voltage for operating the data driver based on the first power supply voltage,
wherein, in the voltage detection circuit, the first to fifth detection units receive the first power supply voltage, the first positive power supply voltage, the first negative power supply voltage, the second positive power supply voltage, and the second negative power supply voltage as the first to fifth voltages, respectively, and
wherein the control unit deactivates the data driver and the gate driver when at least one of the first to fifth voltage detection signals outputted from the first to fifth detection units exceeds a specification range.

6. A voltage detection circuit, comprising:
first to n-th detection circuits, n being an integer of 2 or greater; and
a bias circuit coupled to the first to n-th detection circuits, the bias circuit including
a first transistor coupled to a second transistor;
a third transistor coupled to the first transistor and to a first power supply voltage; and
a fourth transistor coupled to the second transistor and to a second power supply voltage lower than the first power supply voltage;
the first to n-th detection circuits each including
a fifth transistor coupled to a sixth transistor;
a seventh transistor coupled to the fifth transistor and to the first power supply voltage; and
an eighth transistor coupled to the sixth transistor and to the second power supply voltage;
wherein
the bias circuit is configured to output a bias voltage;
each of the third transistor and the fourth transistor is configured to receive the bias voltage;
each of the seventh transistor and the eighth transistor is configured to receive the bias voltage;
each of the first transistor and the second transistor is configured to receive a reference voltage; and
each of the fifth transistor and the sixth transistor is configured to receive a respective one of first to n-th voltages.

7. The voltage detection circuit of claim 6, wherein n is 2; and
wherein
the voltage detection circuit further includes a detection voltage generation circuit configured to receive a third power supply voltage and to output, based on the third power supply voltage, a first voltage and a second voltage higher than the first voltage;
the first voltage and the second voltage define a range of the third power supply voltage;
the first voltage detection circuit is configured to receive the first voltage and to output a first voltage detection signal that takes on binary values;
the second voltage detection circuit is configured to receive the second voltage and to output a second voltage detection signal that takes on binary values;
a first combination of the binary values of the first voltage detection signal and the binary values of the second voltage detection signal corresponds to the third power supply voltage being in an undervoltage state outside of the range;
a second combination of the binary values of the first voltage detection signal and the binary values of the second voltage detection signal corresponds to the third power supply voltage being within the range; and
a third combination of the binary values of the first voltage detection signal and the binary values of the second voltage detection signal corresponds to the third power supply voltage being in an overvoltage state outside of the range.

8. A display driver including the voltage detection circuit of claim 6.

9. A display device including the voltage detection circuit of claim 6.
